(19) United States
(12) Patent Application Publication
(10) Pub. No.: US 2021/0030040 A1
(43) Pub. Date: Feb. 4, 2021

(54) Product and Device for Modifying the Product

(71) Applicant: Flavour Message AG, Zug (CH)

(72) Inventors: Dominik Thormann, Zurich (CH); Jörg Rychen, Zurich (CH)

(21) Appl. No.: 16/969,063

(22) PCT Filed: Feb. 13, 2019
(86) PCT No.: PCT/EP2019/053538

§ 371 Date: Aug. 11, 2020

(30) Foreign Application Priority Data
Feb. 14, 2018 (CH) 00176/18

(51) Int. Cl. A23L 27/00; A23P 10/10; H04L 12/58

(52) U.S. Cl. CPC A23L 27/70; H04L 51/18; A23P 10/10

(57) ABSTRACT

The invention relates to a product (1) comprising a plurality of portions (21-26) of flavouring substances associated with fastening arrangements (31-36; 41′-46′). The fastening arrangements (31-36; 41′-46′) can be modified with energy trans-mitted from an external device (5) in such a manner that the plurality of portions (21-26) of flavouring substances is divided into a first subset (T1) of the plurality of portions (21-26) of flavouring substances enabled to remain with the product (1) and into a second subset (T2) of the plurality of portions (21-26) of flavouring substances enabled for removal from the product (1). The invention further relates to a device for modifying such a product (1).

### BACKGROUND

The present invention relates to a product comprising a plurality of portions of flavouring substances. The product enables creation of a desired flavour. The invention further relates to a device for modifying such a product.

It is known that more than 1000 flavouring substances are involved in the perception of flavours in the human olfactory and gustatory system. In order to comply with the huge variety of flavours desired by consumers, products having a plurality of flavours must be available. This results in very complex productions and logistics. In addition, after fabrication, flavours of products cannot be changed by consumers.

The “Flavor and Extract Manufacturers Association of the United States” (FEMA) discloses a flavour ingredient library (https://www.femaflavor.org/flavor-library/search?fulltext=&synonyms=1), which assigns FEMA numbers to particular ingredients, such as “FEMA 2001” to “Acacia Gum”, etc. A flavouring substance as defined in the present application may comprise single ingredients as defined by FEMA (or as defined elsewhere), any combination of ingredients defined by FEMA, or any other ingredients not yet defined by FEMA or defined at a later time by FEMA or elsewhere. For example, a flavouring substance may comprise a particular set of ingredients having particular properties useful for creating a desired flavour. For example, a particular flavouring substance may include a particular set of ingredients useful for creating a desired flavour of a particular type, such as a “basic” flavour which is required for creating different fruit flavours, e.g. banana, strawberry, etc.

Recently, ingestible products containing microcapsules are well-known to improve the perceiving of the consumers. For example, chewing gums containing special flavours comprises a plurality of microcapsules, in which substances for generating special flavours are packaged. By chewing the gums the microcapsules are destroyed such that the substances stored in the microcapsules are discharged from the microcapsules and mixed into the chewing gums for providing the desired flavours.

However, microcapsules can only be randomly destroyed when products containing microcapsules are consumed. In a specific product, the microcapsules contain a predefined mixture of substances. Therefore, a consumer cannot choose particular microcapsules being destroyed such that a desired flavour may be generated.

### SUMMARY

It is an object of this invention to provide a product and a device which avoid at least some of the disadvantages of the prior art. It is an objective of this invention to provide a product which can be modified at a user location by an external device such that a desired flavour can be created with the product.

According to the present invention, these objectives are achieved through the features of the independent claims. In addition, further advantageous embodiments follow from the dependent claims and the description.

According to the present invention, a product comprises a plurality of portions of flavouring substances associated with fastening arrangements, wherein the fastening arrangements can be modified with energy transmitted from an external device in such a manner that the plurality of portions of flavouring substances is divided into a first subset of the plurality of portions of flavouring substances enabled to remain with the product and into a second subset of the plurality of portions of flavouring substances enabled for removal from the product. At an initial stage, the product includes portions of flavouring substances including various amounts of various flavouring substances. By modification of the fastening arrangements, the portions of flavouring substances are divided into a first and a second subset of portions of flavouring substances, wherein the first subset is enabled to remain with the product and the second subset is enabled for removal from the product. The portions of flavouring substances included in the first subset, the second subset, or in both subsets can be chosen in accordance to desired flavours, enabling a user to create a desired flavour.

An advantage is that by using an electronic device, flavour codes may be transferred either from the manufacturer to the user or also from user to user. These codes may either be known or unknown to the end user himself.

Typically, the removal of the second subset is irreversible. That is, once the first subset remains in the product and the second subset is removed from the product, only the substances of the first subset remain in the product, while the substances of the second subset are irreversibly removed.

Separation of the first subset from the second subset is usually performed by the user himself.

In preferred embodiments, the external device is an electronic device.

In typical embodiments, the flavouring substances comprise pure substances, i.e. pure flavour chemicals, in particular pure olfactory substances. In preferred embodiments, each portion solely contains a single chemical compound, preferably in a predefined amount/concentration. Thus, each portion of flavouring substance may comprise or consist of a pure substance and thus contain only a single chemical compound. Consequently, such portions do not contain mixtures of different chemical compounds. In further embodiments, some of the portions may also comprise a mixture of substances. These embodiments are of particular advantage, as it is the user himself who may perform the formulation of the desired flavour from pure substances. This is in contrast to many other known devices using mixtures, in which the mixtures are prepared and provided by the manufacturer and not by the user. Therefore in these embodiments according to the invention, the user may act himself as a flavour and/or fragrance formulator. Furthermore, when pure substances are used, a highly versatile product is provided, in the case of pure substances, very small modifications in composition and/or amount has a large impact on the resulting flavour and/o fragrance.

In some embodiments, the flavour substances are olfactory substances or exclusively olfactory substances.

Typically the first subset of portions remaining in the product contains more than one individual portion.

Furthermore, more than one individual portion may be contained in the second subset and thus more than one individual portion are removed.

In other embodiments, manipulation or modification of the fastening elements may release the flavouring substances contained in the portions of the first subset. Thus, the fastening arrangements enable release of the flavour substances contained in first subset.

In typical embodiments, the product further comprises a consumable, which is prior to manipulation or modification of the fastening arrangements not in direct contact with any of the flavouring substances. Manipulation or modification of the fastening elements may allow for release the flavouring substances contained in the portions of the first subset or the second subset. Consequently, modification enables not only separation of the first subset and the second subset, but also release of a selectable plurality of flavouring substances. The consumable may be a confectionary product, a chewing gum, a candy, a beverage or any other type of food. It is further possible that the consumable is removed together with the second subset of flavouring substances.

In some embodiments, the second subset of the plurality of portions of flavouring substances for removal from the product can be removed from the product on the basis of gravity, flush out with a liquid and/or removal of a removable member of the product. For example, the portions of flavouring substances can be arranged on the top of the product and after modification of the fastening arrangements, the second subset of portions of flavouring substances can be removed from the product by turning the product upside down. For example, the product can include a removable member, wherein fastening arrangements enable connection of the second subset of portions of flavouring substances to the removable member, and wherein the second subset can be removed from the product by removal of the removable member, for example by manual removal.

For example, the product may be a chewing gum and the removable member may be the protection wrapper of the chewing gum. After modification of the fastening arrangements, unneeded flavouring substances may stick to the protection wrapper and are removed with the protection wrapper, while the desired flavouring substances stick to the chewing gum, thereby providing a chewing gum having a desired flavour.

In some embodiments, modification of a fasting arrangement effects fastening a portion of a flavouring substance to the product, fastening a portion of a flavouring substance to a removable member of the product, disengaging a fastening between a portion of a flavouring substance and the product, and/or disengaging a fastening between a portion of a flavouring substance and a removable member of the product. The removable member may include more than one removable part. The portions of flavouring substances can be either fastened to the product or to the removable member.

In some embodiments, the fastening arrangements can be modified by optical energy, thermal energy and/or mechanical energy transmitted from the external device. For example, a smartphone which is readily available at the user location can provide optical energy for modifying the fastening arrangements. For example, a thermal printer or a mechanical printer can provide thermal or mechanical energy for modifying the fastening arrangements. For example, an auxiliary device may be manually manipulated or modified by the user in order to transmit optical energy, thermal energy and/or mechanical energy.

In some embodiments, the fastening arrangements include a glue which can be cured by energy transmitted from the external device, a glue which can be unglued or inactivated, i.e. which can be manipulated or modified such that it does not exert any adhesive behaviour, by energy transmitted from the external device, a connector member which can be brought into function by energy transmitted from the external device, a connector member which can be put out of function by energy transmitted from the external device, a closure cap which can be brought into function by energy transmitted from the external device, and/or a closure cap which can be put out of function by energy transmitted from the external device. For example, a glue included in the fastening arrangements can be cured or unglued or inactivated by optical energy transmitted by a smartphone. For example, a mechanical printer can punch specific fastening arrangements.

In some embodiments, the product includes a substrate and a removable member, wherein the product includes one or more first fastening arrangements arranged between the substrate and the portions of flavouring substances, and/or one or more second fastening arrangements arranged between the portions of flavouring substances and the removable member. The first subset of portions of flavourings substances can be connected to the substrate of the product and disconnected from the removable member. The second subset of portions of flavouring substances can be disconnected from the substrate of the product and connected to the removable member.

In some embodiments, the product includes one or more cavities having arranged a portion of a flavouring substance, each cavity including a closure cap embodying a fastening arrangement. For example, the cavities and the closure caps can have a cylindrical design. For example, the portions of flavouring substances can include a powder, a liquid, a gel, a paste, etc.

In some embodiments, the product further comprises a removable protection member which protects the fastening arrangements from modification. The removable protection member may provide a light protection, a thermal protection, and/or a mechanical protection, such that the fastening arrangements remain protected from inadvertent modification prior to use of the product. For example, such a protection element may temporally shield the fastening elements from manipulation or modification, for example by shielding optical, thermal or mechanical energy. The protection element may for example be a removable cover, such as aluminium foil or a thermally insulating layer.

In some embodiments, the product further comprises a removable envelope which protects the product from pollution. The removable envelope may include a protection member protecting the fastening arrangements from modification or manipulation.

In some embodiments, the portions of flavouring substances include doses of flavouring substances in accordance to a predefined dosage scheme.

In some embodiments, the location of the portions of flavouring substances and/or the location of the fastening arrangements are defined in accordance to a predefined location scheme.

In some embodiments, the product includes identification means for determining features of the product, the features including the number of portions of flavouring substances, the sorts of the flavouring substances, the amounts of flavouring substances, and/or the location of the portions of flavouring substances and/or the fastening arrangements. For example, the location of the portions of flavouring substances and/or the fastening arrangements may be defined with respect to a coordinate system defined with respect to the product. For example, the identification means can be in the form of touch points or detectable elements arranged on the product. In particular, the touch points or detectable elements can be detected by a multi-touch screen of a smartphone. For example, the identification means enable lookup of features of the product in a central database.

In some embodiments, the product includes an ingestible product, a flavouring product, a confectionary product, a phytologic product, a stimulant, a beverage, a function food product, a candy, a chewing gum, and an ingestible paper. The product can be designed for a wide variety of applications.

In some embodiments, at least one flavouring substance includes a denaturing substance. The denaturing substance can be stored in one of the portions of the flavouring substances, which must be correctly determined for example on the basis of identification means included in the product, and which denaturing substance must be removed before use of the product.

Beside a product as described above, the invention relates to a device for modifying such a product. The device is enabled to transmit energy to the product in such a manner that one or more fastening arrangements of the product are modified or manipulated and that the plurality of portions of flavouring substances is divided into the first subset of the plurality of portions of flavouring substances enabled to remain with the product and into a second subset of the plurality of portions of flavouring substances enabled for removal from the product. Typically, the removal of the second portion of flavouring substances is irreversible.

In some embodiments, the device is enabled for transmission of optical energy, for transmission of thermal energy, and/or for transmission of mechanical energy to the product. Thus, the device is typically an electronic device.

In some embodiments, the device is enabled to transmit energy to the product in accordance to an activation pattern. The activation pattern modifies or manipulates the fastening arrangements and divides the portions of flavouring substances into a first and a second subset. It is therefore possible that specific portions of flavouring substances are modified or manipulated. The selection of which portions are modified or manipulated can either be done via a code or directly by manual selection of the user via the device. For example, the device may present choices of predefined flavours or present each portion with the associated flavour, preferably with the associated pure chemical compound, to the user.

In some embodiments, the device is further enabled for detecting presence and relative orientation of the product with respect to the device, in particular in that the device includes a multi-touch screen which is enabled for detecting position of touching members arranged on the product reflecting the presence and relative orientation of the product with respect to the device.

In some embodiments, the device is enabled to adapt the activation pattern to the detected presence and relative orientation of the product.

In some embodiments, the device is enabled to access identification means of the product, in particular in that the device includes a multi-touch screen which is enabled for detecting the position of touch-pins arranged on the product embodying the identification means. As described above in connection with one of the embodiments of the product, the product includes identification means for determining features of the product.

In some embodiments, on the basis of the access to the identification means, the device is enabled to lookup information enabling modification or manipulation of fastening arrangements in a database, in particular by accessing a database stored in the device and/or by contacting a database of a remote server.

In some embodiments, the device is an electronic device, in particular a smartphone, a tablet computer, a laptop computer, or a display connected to a desktop computer.

### BRIEF DESCRIPTION OF THE DRAWINGS

In order to describe the manner in which advantages and features of the disclosure can be obtained, in the following a more particular description of the principles briefly described above will be rendered by reference to specific embodiments thereof which are illustrated in the appended drawings. These drawings depict only exemplary embodiments of the disclosure and are not therefore to be considered to be limiting of its scope. The principles of the disclosure are described and explained with additional specificity and detail through the use of the accompanying drawings in which:

FIG. 1a,1b,1c illustrate a product according to a first initial stage, a second stage, and a third, end stage;

FIG. 2a, 2b, 2c illustrate a product according to a first initial stage, a second stage, and a third, end stage;

FIG. 3 illustrates a top view of a product according to a first, initial stage;

FIG. 4 illustrates a top view of a product according to a third, end stage;

FIG. 5a illustrates a mobile device which can transmit optical energy to a the fastening arrangements of a product;

FIG. 5b illustrates a product adapted for use with the mobile device illustrated in FIG. 5a.

FIG. 5c illustrates the product illustrated in FIG. 5b arranged on the mobile device illustrated in FIG. 5a;

FIG. 5d illustrates the product according to a third, end stage;

FIG. 6a illustrates a product arranged on a mobile device in accordance to a specific orientation;

FIG. 6b illustrates detecting the specific orientation of a product arranged on a mobile device;

FIG. 7a illustrates a product including portions of flavouring substances,

FIG. 7b illustrates a product enabling detection of orientation of the product and detection of assignment information, respectively an encoding;

FIG. 8a illustrates a mobile device contacting a central database in accordance to assignment information of a product arranged on the mobile device;

FIG. 8b illustrates transmitting optical energy by a mobile device in accordance to assignment information received from a central database;

FIG. 9a illustrates a cross-sectional view of an embodiment of a product according to the invention;

FIG. 9b illustrates a top vie of the product illustrated in FIG. 9a; and

FIG. 10a,10b,10c illustrate a product according to a first initial stage, a second stage, and a third, end stage.

Helpful for a more complete understanding of the present application are the international applications of the same applicant as the present applicant, namely the international applications No. PCT/EP2016/054474, PCT/EP2017/071896, PCT/EP2017/071897, PCT/EP2017/071898. These applications are included herewith by reference.

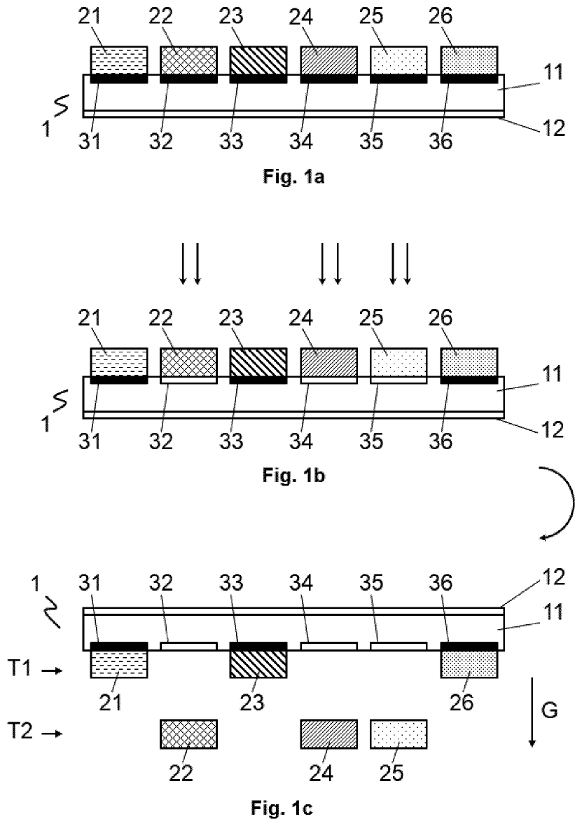

FIGS. 1a,1b,1c illustrate schematically a first, initial stage, a second stage, and a third end stage of a product 1 according to the present invention.

The product 1 comprises a plurality of portions 21-26 of flavouring substances. Each portion may include a particular amount of a particular flavouring substance. One or more portions may include a similar or the same amount of a particular flavouring substance. One or more portions may include a similar or the same flavouring substance. The different amounts and/or different flavouring substances are illustrated in FIGS. 1a, 1b, 1c by portions 21-26 of flavouring substances having different patterns.

One or more portions 21-26 of flavouring substances may be stored in storage elements such as containers, spheres, globules, etc.

The portions 21-26 of flavouring substances and/or the storage elements storing the portions 21-26 of flavouring substances may have any state of matter, such as solid, gaseous, or liquid, they may have any physical shape, such as spherical, cuboid, pyramidal, etc., and any mixture thereof. FIG. 1a illustrates schematically portions 21-26 of flavouring substances in the form of cuboids. For example, the portions 21-26 of flavouring substances are stored in storage elements having the form of a cuboid. In other embodiments, the portions 21-26 of flavouring substances have the form of a powder, a gel, a paste, a platelet, etc.

As illustrated in FIGS. 1a, 1b, 1c, the portions 21-26 of flavouring substances are associated with fastening arrangements 31-36 The fastening arrangement with reference sign 31 is associated with the portion with reference 21. The remaining portions are associated accordingly with the remaining fastening arrangements.

The product 1 illustrated in FIGS. 1a, 1b, 1c includes a substrate 11 having a bottom plate 12. The fastening arrangements 31-36 can be arranged at the top part of the substrate 11. The bottom plate 12 is not a mandatory feature. The bottom plate 12 is defined in the description of the exemplary product 1 illustrated in FIGS. 1a, 1b, 1c for illustrative purposes only. For example, the fastening arrangements 31-36 may be arranged in respective recesses of the substrate 11.

For example, the fastening arrangements 31-36 may include a glue which can be cured by energy transmitted from an external device, or which can be unglued or inactivated by energy transmitted from the external device. The fastening arrangements 31-36 may include further or other elements as described below.

At the first stage, which is the initial stage, as illustrated in FIG. 1a, the portions 21-26 of flavouring substances are arranged on top of the fastening arrangements 31-36 Each portion 21-26 of a flavouring substance is associated with a corresponding fastening arrangement 31-36.

In the example illustrated in FIG. 1a, the product 1 includes fastening arrangements 31-36 which include a glue which can be unglued or inactivated by energy transmitted from the external device. The glue of the fastening arrangements 31-36 establishes a connection between the respective portions 21-26 of flavouring products and the product 1, namely the substrate 11, thereby fastening the respective portion 21-26 of a flavouring substance to the product 1, namely to the substrate 11. The glue of particular fastening arrangements 31-36 can be unglued or inactivated by energy transmitted from the external device, wherein the connection between the respective portion 21-26 of a flavouring substance and the product 1, namely the substrate 11, is released, thereby separating the fastening between the respective portion 21-26 of a flavouring substance and the product 1, namely the substrate 11.

The glue of the fastening arrangements 31-36 is illustrated by the fastening arrangements 31-36 having a black colour. Thus, at the first stage illustrated in FIG. 1a, the portions 21-26 of flavouring substances are connected via the fastening arrangements 31-36 to the substrate 11, thereby fastening the portions 21-26 of flavouring substances to the product 1, namely the substrate 11.

At a second stage illustrated in FIG. 1b, energy is transmitted from the external device to the fastening arrangements 31-36 For example, optical energy having a desired pattern is transmitted from the external device to the fastening arrangements 31-36 In FIG. 1b, the optical energy having the desired pattern is illustrated with arrows. In the present example, the desired pattern of optical energy is chosen such that a first subset T1 of portions 21, 23, 26 of flavouring substances remains connected via the respective fastening arrangements 31, 33, 36 to the substrate 11, and that the connection to the substrate 11 via the respective fastening arrangements 32, 34, 35 of a second subset T2 of portions 22, 24, 25 of flavouring substances is released. As the fastening arrangements 31-36 include a glue which can be unglued or inactivated by transmission of optical energy from the external device, the desired pattern is chosen such that no optical energy is transmitted to the fastening arrangements with reference signs 31, 33, 36 of the first subset T1 of portions 21, 23, 26 of flavouring substances, thereby enabling that these portions 21, 23, 26 of flavouring substances remain with the product 1, and that optical energy is transmitted to the fastening arrangements with reference signs 32, 34, 35 of the second subset T2 of portions 22, 24, 25, thereby enabling that these portions 22, 24, 25 are enabled for removal from the product 1. In other words, the glue of the fastening arrangements 31, 33, 36 of the first subset of portions 21, 23, 26 effects that these portions 21, 23, 26 remain fastened to the product 1, namely to the substrate 11, which is illustrated by black fastening arrangements 31, 33, 36, while the glue of the fastening arrangements 32, 34, 35 of the second subset T2 of portions 22, 24, 25 is unglued or inactivated, thereby effecting that the fastening between the second subset T2 of portions 22, 24, 25 and the product 1, namely with the substrate 11, is separated, which is illustrated by white fastening arrangements 32, 34, 35.

In other words, by transmission of energy from an external device to one or more fastening arrangements 39-36 associated with the portions 21-26 of flavouring substances, either a connection between one or more of the portions 21-26 and the substrate 11 of the product 1 is established, thereby fastening the respective portions 21-26 to the product 1, or alternatively a connection between one or more of the portions 21-26 and the substrate 11 of the product 1 is released, thereby effecting that a fastening between respective portions 21-26 and the product 1 is separated. If no energy is transmitted from the external device to one or more fastening arrangements 31-36 the respective fastening arrangements 31-36 remain unchanged, namely either a connection remains established between the respective portions 21-26 and the substrate 11 of the product 1, such that the respective portions 21-26 remain fastened to the product 1, or a connection which could be established by external energy remains released between the respective portions 21-26 and the substrate 11 of the product 1, such that a fastening between the respective portions 21-26 and the product 1 remains separated.

Thus, after the second stage, the fastening arrangements 31-36 associated with the portions 21-26 of flavouring substances have been modified or manipulated with energy transmitted from an external device such that a first subset T1 of portions 21, 23, 26 of flavouring substances is enabled to remain with the product 1, while a second subset of portions 22, 24, 25 are enabled for removal from the product 1. The portions 21-26 of flavouring substances have been divided into a first subset T1 of portions of flavouring substances enabled to remain with the product and a second subset T2 of portions of flavouring substances enabled for removal from the product 1.

At a third stage, which is the end stage, as illustrated in FIG. 1c, the portions 22, 24, 25 enabled for removal from the product 1 are removed from the product 1 by turning around the product 1 upside down. Thus, the bottom plate 12 is at the top of the product 1 and the portions 21-26 are at the bottom of the product 1. As illustrated in FIG. 1c, the second subset T2 of portions 22, 24, 25 of flavouring substances enabled for removal from the product 1 are removed from the product 1 by gravity force G, or, in other words, fall down from the product 1 due to gravity forces. The first subset T1 of portions 21, 23, 26 of flavouring substances are connected to the substrate 11 via the fastening arrangements 31, 33, 36, and therefore remain with the product.

Depending on the application, the first subset T1 of portions of flavouring substances creates a desired flavour, or the second subset T2 of portions of flavouring substances creates a desired flavour.

In an embodiment, the second subset T2 of portions of flavouring substances can be removed from the product by flushing them out with a liquid, for example by dipping and shaking the product in a liquid, thereby creating a drink having a desired flavour.

According to the first stage, the second stage and the third stage described above, the initial product 1 of the first stage, which includes portions of flavouring substances including various flavouring substances, is modified or manipulated such that the end product 1 of the third stage includes a first subset T2 of portions of flavouring substances which create a desired flavour. However, alternatively or as well, a desired flavour can be created by the second subset T2 of portions of flavouring substances which have been removed from the product 1.

Instead of a glue which can be unglued or inactivated by energy transmitted from an external device, the fastening arrangements 31-36 may include a glue which can be cured by energy transmitted from an external device. Thus, at the first stage, the portions 21-26 are not yet connected to the substrate 11, because the glue is not yet cured, and would fall down upon turning the product 1 upside down due to gravity forces. At the second stage, by transmission of energy from the external device in accordance to a specific transmission pattern, the glue included in one or more fastening arrangements 31-36 is cured such that a first subset T1 of portions 21, 23, 26 of flavouring substances is connected via the respective fastening arrangements 31, 33, 36 to the substrate 11. In accordance to the specific transmission pattern, the second subset T2 of portions 22, 24, 25 of flavouring substances remain unconnected to the substrate 11, because the glue of the respective fastening arrangements 32, 34, 35 is not cured. At the third stage, by turning the product 1 upside down, the second subset T2 of portions 22, 24, 25 of flavouring substances are removed from the product 1 by gravity.

Various types of glues may be employed. For example, http://bucktownpolymers.com/rcpolymers00.html lists various types of glue, including glue type ZVE200-V470 which can be cured using optical energy of a normal pocket LED projector (LED: light emitting diode). Further glues are known which also have an edible property.

Various types of glues can be adapted to be unglued or inactivated or cured in accordance to various kinds of energy, such as various kinds of optical energy, thermal energy, etc. The various kinds of energy can include various frequencies, intensities, etc. For example, a first type of glue can be unglued or inactivated by optical energy of a first frequency and a first intensity, a second type of glue can be unglued or inactivated by optical energy of a second frequency and a second intensity, a third type of glue can be cured by optical energy of a third frequency and a third intensity, etc.

Some of the fastening arrangements 31-36 may include a glue which can be cured by transmission of optical energy, while others of the fastening arrangements 31-36 may include a glue which can be unglued or inactivated by transmission of optical energy. The transmission pattern of optical energy of the second stage may be chosen in accordance to the glue of the respective fastening arrangements 31-36 such that a first subset T1 of portions 21, 23, 26 of flavouring substances is enabled to remain with the product 1, while a second subset of portions 22, 24, 25 of flavouring substances is enabled for removal from the product 1.

The one or more fastening arrangements 31-36 can be designed such that when the external device transmits energy in the form of optical energy, thermal energy, and/or mechanical energy, a connection between the portions 21-26 of flavouring substances and the product 1 is established or released. For example, the fastening arrangements 31-36 can include a glue which can be cured or unglued or inactivated by optical energy as described above. For example, the fastening arrangements 31-36 can include a glue which can be cured or inactivated by thermal energy. For example, the fastening arrangements 31-36 can include a mechanical member which can be brought into a connected state or a disconnected state by mechanical energy. Other designs are possible as well. Thus, the fastening arrangements can be designed such that a fastening between respective portions 21-26 of flavouring substances and the product 1 is effected, or that separation of a fastening between respective portions 21-26 of flavouring substances and the product 1 is effected.

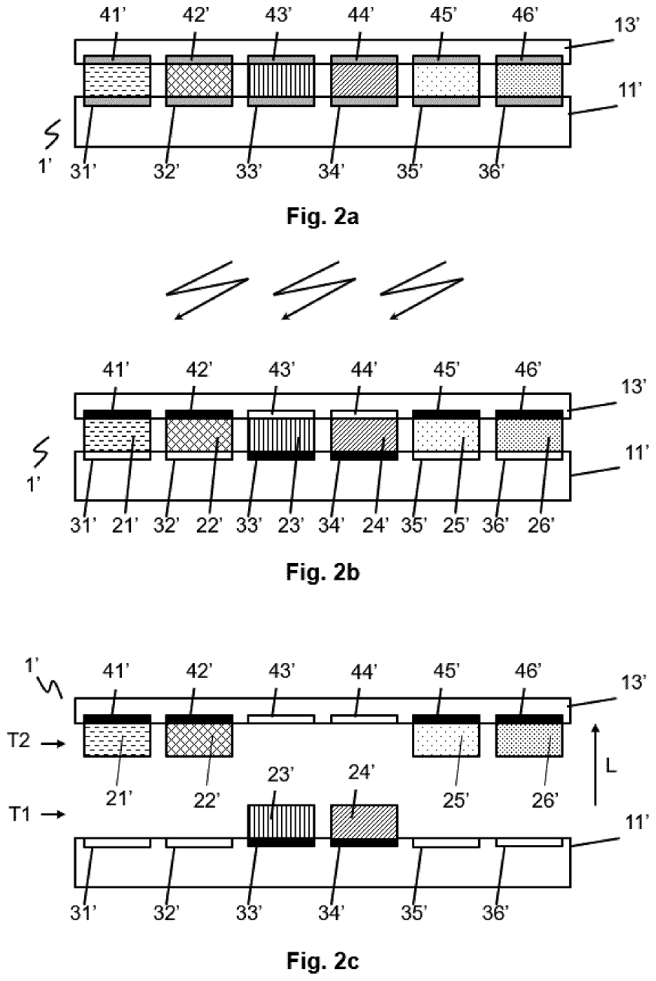

FIGS. 2a, 2b, 2c illustrate schematically a first, initial stage, a second stage and a third stage of an alternative embodiment of a product 1′ according to the present invention. The alternative embodiment of the product 1′ includes portions 21′-26 of flavouring substances which include flavouring substances such that a first subset T1 or a second subset T2 of the portions 21′-26′ create a desired flavour. FIG. 2a illustrates the product 1′ at a first, initial stage, FIG. 2b illustrates the product 1′ at a second stage, and FIG. 2c illustrates the product 1′ at a third, end stage.

The portions 21, 22, 23, 24 of flavouring substances can be embodied in various ways, as explained above in connection with FIGS. 1a, 1b, 1c.

The product 1′ includes a substrate 11′ and a removable member 13′. The product 1′ includes first fastening arrangements 31′-36′ arranged between the substrate 11′ and the portions 21′-26′ of flavouring substances. The product includes second fastening arrangements 41′-46′ arranged between the removable member 13 and the portions 21′-26′ of flavouring substances.

FIG. 2a illustrates the product 1′ at a first, initial stage. The first fastening arrangements 31′-31′ respectively the second fastening arrangements 41′-46′ are designed such that either a connection between the respective portions 21′-26′ of flavouring substances and the substrate 11′ respectively the removable member 13′ is either established (and can be released upon receipt of energy from the external device), or is released (and can be established upon receipt of energy from the external device), which is illustrated in FIG. 2a with fastening arrangements 31′36′ having a grey colour.

At the second stage illustrated in FIG. 2b, by transmission of energy from an external device, a connection between specific portions 21′-26′ and the substrate 11′ respectively the removable member 13′ can be brought from an established state into a released state or from a released state into an established state. For example, the first fastening arrangements 31′-36′ respectively the second fastening arrangements 41′46′ can include a glue which can be cured or unglued or inactivated thereby providing a connection having an established state and a connection having a released state. For example, the first fastening arrangements 31′-36′ respectively the second fastening arrangements 41′-46′ can include a mechanical member which can provide for a connection having a released state and for a connection having an established state. The first fastening arrangements 31′-36′ respectively the second fastening arrangements 41′-46′ can be designed that transition from the established state to the released state or transition from the released state to the established state can be effected by transmission of optical energy, thermal energy and/or mechanical energy from the external device. Transmission of energy from the external device is illustrated in FIG. 2b by flashes and arrows.

According to the example illustrated in FIG. 2b, the first fastening arrangements with reference signs 31′, 32′, 35′, 36′ have been brought into a released state, which is illustrated by the respective first fastening arrangements having a white colour, wherein the first fastening arrangements with reference signs 33′, 34′ have been brought into an established state, which is illustrated by the respective first fastening arrangements having a black colour. The second fastening arrangements with reference signs 41′, 42′, 45′, 46′ have been brought into an established state, which is illustrated by the respective second fastening arrangements having a black colour, wherein the second fastening arrangements with reference signs 43′, 44′ have been brought into a released state, which is illustrated by the respective second fastening arrangements having a white colour.

Thus, the first fastening arrangements 31′-36′ can be modified or manipulated such that one or more portions 21′-26′ of flavouring substances can be fastened to the product 1′, namely the substrate 11′, or a fastening between one or more portions 21′-26′ of flavouring substances and the product 1′, namely the substrate 11′, can be separated. The second fastening arrangements 41′-46′ can be modified or manipulated such that one or more portions 21′-26′ of flavouring substances can be fastened to the removable member 13′ of the product 1′, or a fastening between one or more portions 21′-26′ of flavouring substances and the removable member 13′ of the product 1′ can be separated.

At the third, end stage illustrated in FIG. 2c, the removable member 13′ is removed from the product 1′, namely from the substrate 11′, by application of a lift-off force L. For example, the removable member 13′ is removed by application of a manual force of a user of the product 1′. As illustrated in FIG. 2c, the portions 23′, 24′ of a first subset T1 remain with the product, wherein the portions 21′, 22′, 25′, 26′ of a second subset T2 are removed from the product together with the removable member 13′. At the third, end stage, the product 1′ includes the first subset T1 of portions 23′, 24′ of flavouring substances, while a second subset T2 of portions 21′, 22′, 25′, 26′ of flavouring substances has been removed together with the removable member 13′.

The stage illustrated in FIGS. 1b, 2b can include a multi-step process. For example, in a first step energy of a first kind is transmitted from the external device, and in a second step energy of a second kind is transmitted from the external device. For example, the energy of the first kind includes optical energy of a first frequency, and the energy of the second kind includes optical energy of a second frequency. For example, the energy of the first kind includes optical energy, and the energy of the second kind includes thermal energy. Various combinations are possible.

The stage illustrated in FIGS. 1b, 2b can include a sequence of transmissions of different kinds of energy by the external device. Alternatively or additionally, a first kind and a second kind of energy can be transmitted simultaneously by the external device.

Different kinds of energy can be related to different frequencies of energy, such as different frequencies or wavelengths of optical energy, thermal energy, or mechanical energy, different intensities of energy, such as different intensities of optical energy, thermal energy, or mechanical energy, etc.

The external device can include a generator for generating optical energy, such as a projector, a screen, etc., for generating thermal energy, such as infrared or near infrared devices, or for generating mechanical energy, such as in the form of a matrix printer.

FIGS. 1a, 1b, 1c, 2a, 2b, 2c illustrate a cross-sectional view of the product 1, 1′.

As illustrated in FIGS. 1a, 1b, 1c, 2a, 2b, 2c, the fastening arrangements 31-36 respectively the first fastening arrangements 31′36′ can be arranged between the portions 21-26, 21′-26′ of flavouring substances and the substrate 11 respectively 11′. The second fastening arrangements 41′-46′ can be arranged between the portions 21′26′ of flavouring substances and the removable member 13′.

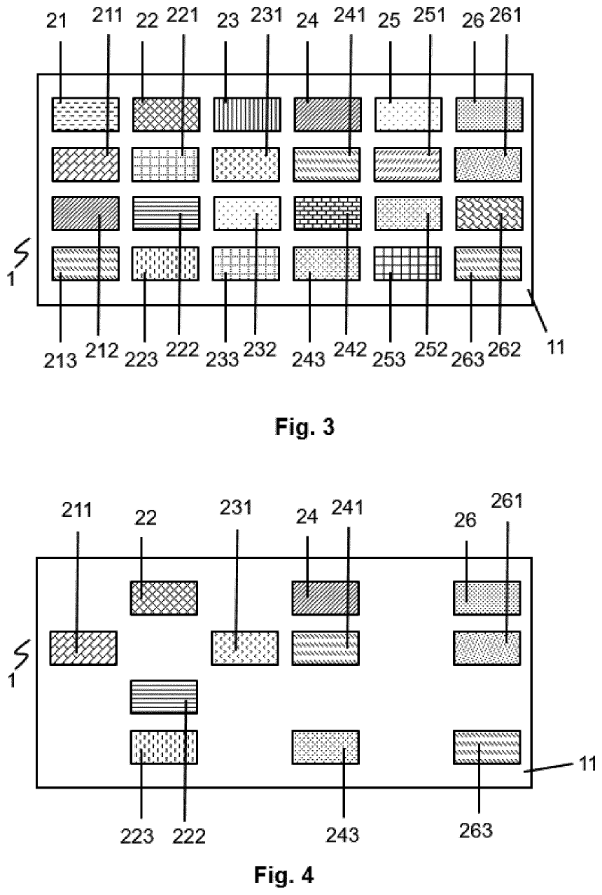

FIG. 3 illustrates a top view of the product 1, 1′. FIG. 3 illustrates only the substrate 11 and the portions 21-26, 211, 221, 231, 241,251, 261, 212, 222, 232, 242,252, 262, 213, 223, 233, 243, 253, 263 of flavouring substances. The portions 21-26, 211, 221, 231, 241,251, 261, 212, 222, 232, 242,252, 262, 213, 223, 233, 243, 253, 263 of flavouring substances include various amounts of various flavouring substances. The fastening arrangements associated with the portions of flavouring substances are included in the product 1, 1′, but not illustrated in FIG. 3. The fastening arrangements can be modified or manipulated with energy transmitted from an external device such that the portions of flavouring substances is divided into a first subset of portions of flavouring substances enabled to remain with the product, and into a second subset of portions of flavouring substances enabled for removal from the product 1.

FIG. 4 illustrates the product 1 after the second subset of portions of flavourings substances enabled for removal from the product 1 have been removed. The first subset of portions 22, 24, 26, 211, 231, 241, 261, 222, 223, 243, 263 of flavouring substances remains with the product 1. Either the first subset or the second subset or both subsets include flavouring substances which create a desired flavour or two different desired flavours, namely a flavour which remains with the product and a flavour which is removed from the product.

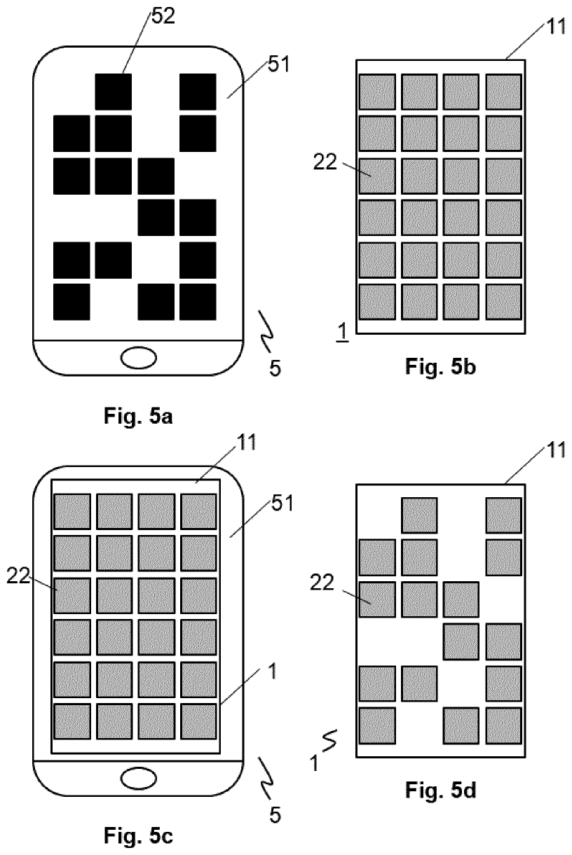

FIG. 5a illustrates a mobile device 5 which can transmit optical energy to a product 1. The mobile device 5 includes a screen 51 which can transmit optical energy in accordance to a predefined pattern. The predefined pattern 52 can be defined in accordance to various kinds of optical energy, such as various frequencies, various intensities, etc. In an embodiment, the mobile device 5 is a smartphone operating the Android™ or iOS™ operating system. The mobile device 5 can run a specifically designed App for controlling transmission of optical energy by the screen 51 in accordance to the present invention.

As illustrated in FIG. 5a by black coloured squares 52, the mobile device 5 can transmit a specific pattern of optical energy by the screen 51.

FIG. 5b illustrates a product 1 adapted for use with the mobile device 5 according to FIG. 5a. The product 1 includes a substrate 11 and portions 22 of flavouring substances including various amounts of various flavouring substances. The portions 22 of flavouring substances are illustrated by a grey colour in FIG. 5b. The product 1 includes fastening arrangements associated with the portions 22 of flavouring substances as described above. The fastening arrangements are not shown in FIG. 5b.

FIG. 5c illustrates the mobile device 5 having arranged on the screen 51 the product 1 illustrated in FIG. 5b. In accordance to the pattern of optical energy transmitted by the screen 51 of the mobile device 5, fastening arrangements are modified or manipulated in such a manner that the portions of flavouring substances is divided into a first subset of portions of flavouring substances enabled to remain with the product 1, and into a second subset of portions of flavouring substances enabled for removal from the product 1. As described above, modification or manipulated of the fastening arrangements may include curing or ungluing a glue included in the respective fastening arrangements with optical energy.

FIG. 5d illustrates the product 1 after removal of the second subset of portions of flavouring substances. As described above, the second subset of portions of flavouring substances can be removed by gravity forces, by flushing them out with a liquid, or by removal of a removable member connected to each of the other portions of flavouring substances. After removal of the second subset of portions of flavouring substances, the product 1 includes a first subset of portions of flavouring substances. Depending on the application, each or both of the first and second subset of portions of flavouring substances can create a desired flavour.

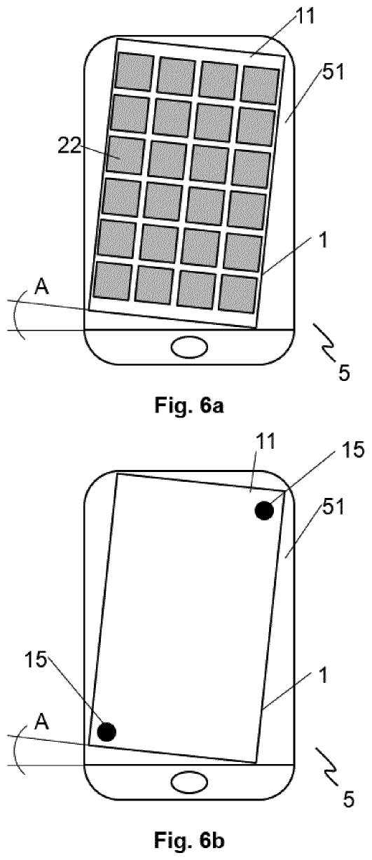

FIG. 6a illustrates a product 1 placed on the screen 51 of a mobile device 5. The product 1 may be placed by a user manually on the screen 51 of the mobile device 5, wherein the product 1 and the screen 51 are aligned to each other in accordance to a specific orientation A. In order to correctly modify the fastening arrangements associated with the portions 22 of flavouring substances of the product 1, transmission of a specific pattern of optical energy by the screen 51 must be adapted in accordance to the orientation A.

FIG. 6b illustrates a product 1 having arranged detectable elements 15 for detecting the orientation A between the screen 51 of the mobile device 5 and the product 1. For example, two or more detectable elements 15 can be arranged, wherein the screen 51 is designed as a multi-touch screen enabled to correctly detect the position of the detectable elements 15. The detectable elements 15 can include conducting elements, pins, etc. The screen 51 can be designed as a multi-touch screen enabled to register simultaneous touches, such as five or more simultaneous touches.

Orientation A of the product 1 with respect to the screen 51 can be achieved by other means, for example a rectangle can be displayed wherein the product has to be placed on the screen accordingly. Instead of a screen 51, a beamer may be provided, wherein orientation A of the product with respect to the beamer can be detect by a camera.

The mobile device 5 can be designed that the pattern of optical energy is transmitted by the screen 51 in accordance to the orientation A detected on the basis of the detectable elements 15, thereby modifying respective fastening arrangements associated with portions 22 of flavouring substances of the product 1 such that a first subset of portions 22 of flavouring substances is enabled to remain with the product 1, and that a second subset of portions 22 of flavouring substances is enabled for removal from the product 1. For example, the corresponding App running on the mobile device 5 can be designed accordingly.

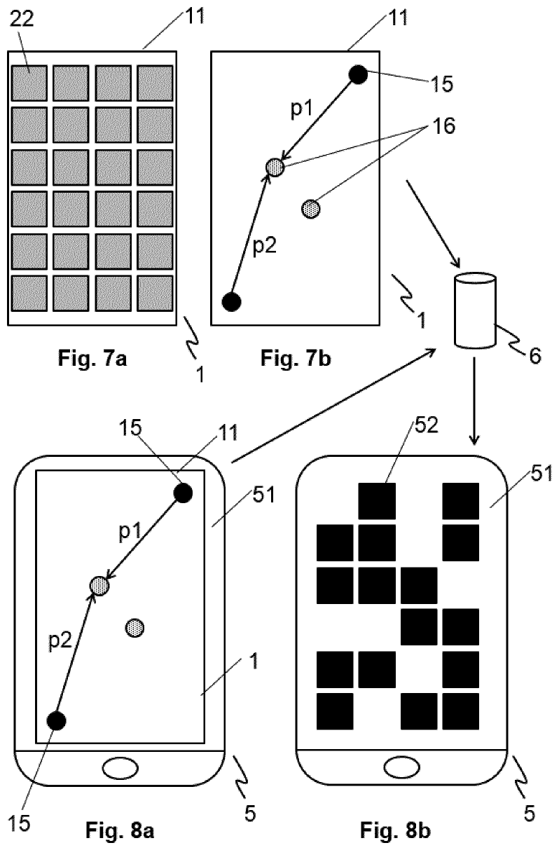

FIG. 7a illustrates schematically a product 1 including a substrate 11 and portions 22 of flavouring substances as described above. As illustrated in FIG. 7b, the product 1 can include detectable elements 15 for detecting the orientation between the product 1 and a screen 51 of a mobile device 5. As illustrated in FIG. 7b, the product 1 can further include one or more detectable elements 16 for determining an encoding defining the amounts and flavouring substances included in the portions 22 of flavouring substances. One or more detectable elements 16 can be arranged on the product 1. The one or more detectable elements 16 can embody identification means accessible by the mobile device 5. The detectable elements 16 for detecting an encoding can be arranged at one or more specific positions p1, p2 with respect to the detectable elements 15 for detecting the orientation between the product 1 and the screen 51. According to the specific positions p1, p2, by lookup in a database for example, it can be determined how to modify the fastening arrangements in order to divide the portions 22 of flavouring substances into a first subset which remains with the product and into a second subset which will be removed from the product, such that the first subset and/or the second subset create a desired flavour.

A plurality of products 1 can be produced having differently arranged detectable elements 16 defining by their arrangement respectively an encoding enabling determining how to modify the fastening arrangements of a particular product in order to divide the portions 22 into a first and second subset as described above. These encodings of the products 1 can be stored in a central database 6, separate from the products 1. Modification or manipulation of the fastening arrangements requires access to the central database 6.

The term encoding corresponds to the term assignment information. The detectable elements 16 embody identification means detectable by the mobile device 5.

The identification means can include an externally readable code attached to the product 1, for example an optically readable barcode, an RFID tag, etc.

FIG. 8a illustrates a product 1 which is placed on a screen 51 of a mobile device 5. The screen 51 is a multi-touch screen, such that the positons of the detectable elements 15, 16 can be determined and orientation A as well as the positions p1, p2. As illustrated in FIG. 8a, in accordance to the positions p1, p2, a lookup in the central database 6 is initiated.

FIG. 8b illustrates that the mobile device 5 receives, in accordance to the encoding, from the central database 6 information defining fastening arrangements associated with the portions of flavouring substances including various amounts and flavouring substances. In accordance to the information, the screen 51 of the mobile device 5 transmits a pattern of optical energy in order to modify the fastening arrangements of the product 1 such that a first subset of portions 22 of flavouring substances is enabled to remain with the product, and that a second subset of portions of flavouring substances is enabled for removal from the product.

The information defining fastening arrangements associated with the portions of flavouring substances can be unrelated to the amounts and the flavouring substances included to the portions of flavouring substances, such that a third party eavesdropping the information cannot determine the recipes involved for creating a desired flavour.

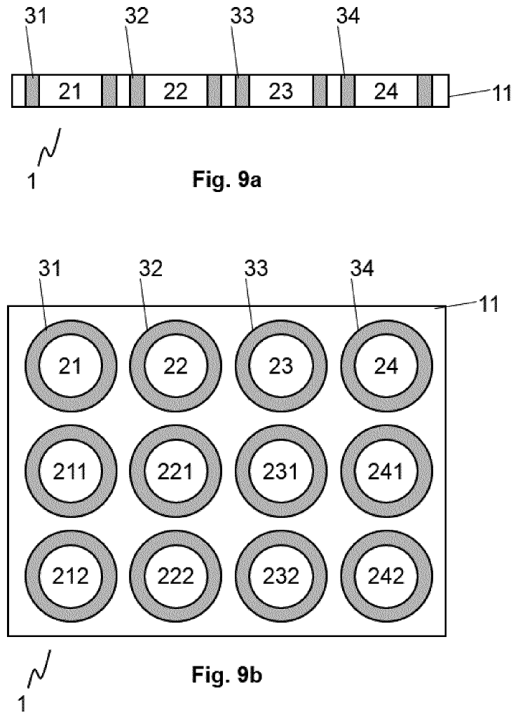

FIG. 9a illustrates the cross-sectional view of an embodiment of a product 1 including a substrate 11 and portions 21, 22, 23, 24 of flavouring substances associated with fastening arrangements 31, 32, 33, 34. The fastening arrangements 31, 32, 33, 34 can be modified or manipulated with energy transmitted from an external device such that a first subset of the portions 21, 22, 23, 24 of flavouring substances is enabled to remain with the product, and that a second subset of portions 21, 22, 23, 24 of flavouring substances is enabled for removal from the product 1.

FIG. 9b illustrates a top view of the product 1 according to FIG. 9a, additionally illustrating further portions 211, 221, 231, 241, 212, 222, 232, 242 of flavouring substances.

As illustrated in FIGS. 9a, 9b, the portions of flavouring substances and the fastening arrangements have a cylindrical design. The portions of flavouring substances and the fastening arrangements extend from the bottom to the top of the substrate.

The fastening arrangements can include mechanical connection members, such that an external device in the form of a matrix printer can remove portions of flavouring substances from the product by punching respective portions of flavouring substances out from the product 1.

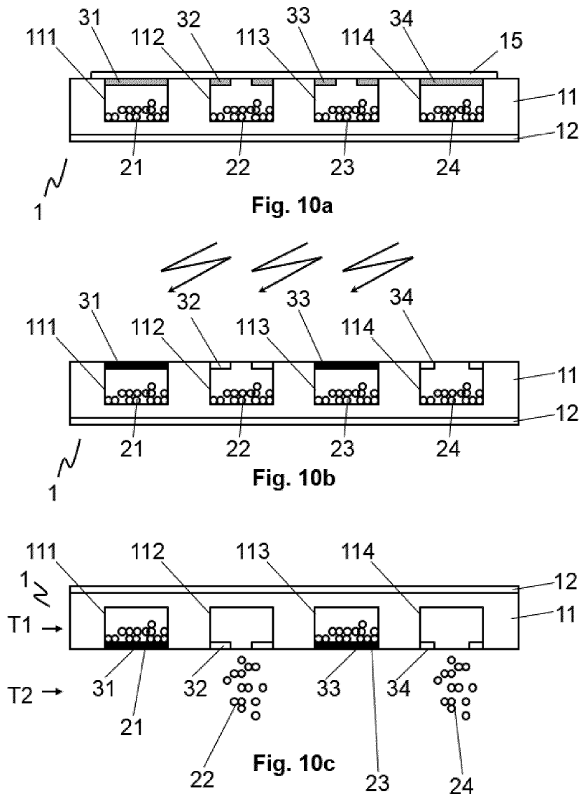

FIGS. 10a,10b,10c illustrate schematically a cross-sectional view of a further embodiment of a product 1 according to a first initial stage, a second stage, and a third, end stage.

As illustrated in FIG. 10a, the product 1 includes a substrate 11 and a bottom plate 12. The substrate 11 includes four cavities 111, 112, 113, 114. However, any number of cavities 111, 112, 113, 114 may be arranged. The cavities 111, 112, 113, 114 may have any kind of geometry, such as a cylindrical geometry, a cubical geometry, a conical geometry, etc. The cavities 111, 112, 113, 114 are designed for storing portions 21, 22, 23, 24 of flavouring substances.

The portions 21, 22, 23, 24 of flavouring substances may have any state of matter, such as solid, gaseous, or liquid, they may have any physical shape, such as spherical, cuboid, pyramidal, etc., and any mixture thereof. FIG. 10a illustrates schematically portions 21, 22, 23, 24 of flavouring substances in the form of a plurality of spheres or globules. In other embodiments, the portions 21, 22, 23, 24 of flavouring substances have the form of a powder, a gel, a paste, a platelet, etc.

As illustrated in FIG. 10a, the portions 21, 22, 23, 24 of flavouring substances are associated with fasting arrangements 31, 32, 33, 34 each having the form of a closure cap arranged in the proximity of a port of the cavities 111, 112, 113, 114, which ports enable that the portions 21, 22, 23, 24 of flavouring substances can be placed inside the cavities 111, 112, 113, 114 or can be removed from the cavities 111, 112, 113, 114.

As illustrated in FIG. 10a, the product 1 includes a protective layer 15 arranged on top of the fastening arrangements 31, 32, 33, 34 in the form of closure caps. The protective layer 15 protects the fastening arrangements 31, 32, 33, 34 from being modified or manipulated with energy transmitted from an external device. In an embodiment, the protective layer 15 includes a light shield for protecting the fastening arrangements 31, 32, 33, 34, which are designed to be sensitive to optical energy, from receiving optical energy. Before use of the product, e.g. before placing the product on a screen of a mobile device 5, the protective layer 5 is removed.

Initially, as illustrated in FIG. 10a, the fastening arrangements 31, 32, 33, 34 having the form of closure caps either occlude the port of a cavity 111, 112, 113, 114, as is the case for the cavities with reference signs 111, 114, or the closure caps do not occlude the port of a cavity 111, 112, 113, 114, as is the case for the cavities with reference signs 112, 113. In this example, after removal of the protective layer 15, the fastening arrangements with reference signs 31, 34 provide that the portions with reference signs 21, 24 of flavouring substances remain with the product, and that the portions with reference signs 22, 23 of flavouring substances are enabled for removal from the product.

As illustrated schematically in FIG. 10b by flashes and arrows, after removal of the protective layer 5, the fastening arrangements 31, 32, 33, 34 are modified or manipulated with energy transmitted from an external device. The fastening arrangements 31, 32, 33, 34 are modified or manipulated depending on the pattern of the energy transmitted from the external device.

In the example illustrated schematically in FIG. 10b, the fastening arrangement with reference sign 31 is not modified or manipulated and the closure cap still occludes the port of the cavity with reference sign 111, such that the portion with reference sign 21 of a flavouring substance is still enabled to remain with the product 1.

In the example illustrated schematically in FIG. 10b, the fastening arrangement with reference sign 32 is not modified or manipulated and the closure cap still does not occlude the port of the cavity with reference sign 112, such that the portion with reference sign 22 of a flavouring substance is still enabled for removal from the product 1.

In the example illustrated schematically in FIG. 10b, the fastening arrangement with reference sign 33 is modified or manipulated such that the closure cap newly occludes the port of the cavity with reference sign 113 and that the portion with reference sign 23 of a flavouring substance is newly enabled to remain with the product 1.

In the example illustrated schematically in FIG. 10b, the fastening arrangement with reference sign 34 is modified or manipulated and the closure cap newly does not occlude the port anymore of the cavity with reference sign 114, such that the portion with reference sign 24 of a flavouring substance still is enabled for removal from the product 1.

In particular, the fastening arrangements 31, 32, 33, 34 in the form of closure caps can be designed such that modification or manipulation with optical energy transmitted from the screen of a mobile device is enabled. Depending on the pattern of the optical energy a set of closure caps can be modified or manipulated or left to occlude the port of the respective cavity 111, 112, 113, 114, and the other closure caps can be modified or manipulated or left not to occlude the port of the respective cavity 11, 112, 113, 114, thereby enabling that a set of portions of flavouring substances is enabled to remain with the product 1, and that the other portions of flavouring substances are enabled for removal from the product 1.

In an embodiment, the subset of portions of flavouring substances enabled to remain with the product 1 can create a desired flavour. In another embodiment, the other portions of flavouring substances enabled for removal from the product 1 can create a desired flavour.

As illustrated in FIG. 10c, the portions 22, 24 of flavouring substances enabled for removal from the product 1 are removed from the product 1 by turning the product 1 upside down. Due to gravity forces, the portions 22, 24 of flavouring substances enabled for removal from the product 1 fall out of the respective cavities 112, 114, because the respective ports of the cavities 112, 114 are not occluded by closure caps.

As illustrated in FIGS. 10a, 10b, 10c, the fastening members 31-34 can be arranged at an opening end of the cavities 111, 112, 113, 114

Although the invention has been explained in relation to its preferred embodiment(s) as mentioned above, it is to be understood that many other possible modifications, manipulations and variations can be made without departing from the scope of the present invention. It is, therefore, contemplated that the appended claims will cover such modifications, manipulations and variations that fall within the true scope of the invention.

### LIST OF REFERENCES

1 product
11 substrate
12 bottom plate
15 protective layer
21-26 portions of flavouring substances
31-36 fastening arrangements
1′ product
11′ substrate
13′ removable member
21′-26′ flavouring substances
31′-33′ first fastening arrangements
41′-46′ second fastening arrangements
G gravity force
L lift-off force
5 mobile device
51 screen
52 pattern transmitting optical energy
6 central database

1. A product comprising a plurality of portions of flavouring sub stances associated with fastening arrangements, wherein the plurality of portions comprises pure flavouring substances, and wherein the fastening arrangements can be modified with energy transmitted from an external electronic device in such a manner that the plurality of portions of flavouring substances is divided into a first subset (T1) of the plurality of portions of flavouring substances enabled to remain with the product and into a second subset (T2) of the plurality of portions of flavouring substances enabled for irreversible removal from the product.

2. The product according to claim 1, wherein the second subset (T2) of the plurality of portions of flavouring substances can be removed, from the product on the basis of one or more of: gravity (G), flush out with a liquid, and/or removal (L) of a removable member of the product.

3. The product according to claim 1, wherein modification of a fastening arrangement effects one or more of: fastening a portion of a flavouring substance to the product, fastening a portion of a flavouring substance to a removable member of the product, disengaging a fastening between a portion of a flavouring substance and the product, and disengaging a fastening between a portion of a flavouring substance and a removable member of the product.

4. The product according to claim 1, wherein the fastening arrangements can be modified by one or more of optical energy, thermal energy and mechanical energy transmitted from the external device.

5. The product according to claim 1, wherein the fastening arrangements include one or more of: a glue which can be cured by energy transmitted from the external device, a glue which can be unglued or inactivated by energy transmitted from the external device, a connector member which can be brought into function by energy transmit ted from the external device, a connector member which can be put out of function by energy transmitted from the external device, a closure cap which can be brought into function by energy transmitted from the external device, and/or a closure cap which can be put out of function by energy transmitted from the external device.

6. The product according to claim 1, wherein the product includes a substrate and a removable member, and wherein the product includes one or more of one or more first fastening arrangements arranged between the substrate and one or more portions of flavouring substances, and one or more second fastening arrangements arranged between one or more portions of flavouring substances and/or the removable member.

7. The product according to claim 1, wherein the product includes one or more cavities having arranged a portion of a flavouring substance, each cavity including a closure cap embodying a fastening arrangement.

8. The product according to claim 1, wherein the product further comprises a removable protection member which protects the fastening arrangements from modification with energy transmitted from an external device.

9. The product according to claim 1, wherein the product includes identification means for determining features of the product, the features including one or more of: the number of portions of flavouring substances, the sorts of the flavouring substances, the amounts of flavouring substances, and the location of the portions of flavouring substances and/or the fastening arrangements.

10. The product according to claim 1, wherein the product includes one or more of: an ingestible product, a flavouring product, a confectionary product, a phytologic product, a stimulant, a beverage, a function food product, a candy, a chewing gum, and/or an ingestible paper.

11. The product according to claim 1, wherein at least one flavouring substance includes a denaturing substance.

12. A device for modifying a product according to claim 1, wherein the device is enabled to transmit energy to the product in such a manner that one or more fastening arrangements of the product are modified and that the plurality of portions of flavouring sub stances is divided into the first subset (T1) of the plurality of portions of flavouring substances enabled to remain with the product and into a second subset (T2) of the plurality of portions of flavouring substances enabled for irreversible removal from the product (1).

13. The device of claim 12, wherein the device is enabled for one or more of transmission of optical energy, transmission of thermal energy, and/or transmission of mechanical energy to the product.

14. The device according to claim 12, wherein the device is enabled to transmit energy to the product in accordance to an activation pattern.

15. The device according to claim 12, wherein the device is enabled for detecting presence and relative orientation of the product with respect to the device, in particular in that the device includes a multi-touch screen which is enabled for detecting position of one or more touching members arranged on the product reflecting the presence and relative orientation of the product with respect to the device.

16. The device according to claim 14, wherein the device is enabled to adapt the activation pattern to the detected presence and relative orientation of the product.

17. The device according to claim 12, wherein the device is enabled to access identification means of the product, in particular in that the device includes a multi-touch screen which is enabled for detecting the position of touch-pins arranged on the product embodying the identification means.

18. The device according to claim 17, wherein on the basis of the access to the identification means, the device is enabled to lookup information enabling modification of fastening arrangements in a data base, in particular by accessing a database stored in the device and/or by contacting a database of a remote server.

19. The device according to claim 12, wherein the device is one of: a smartphone, a tablet computer, a laptop computer, and/or a display connected to a desktop computer.
